(19) United States
(12) Patent Application Publication
(10) Pub. No.: US 2024/0010362 A1
(43) Pub. Date: Jan. 11, 2024

(54) Solar space ship yacht

(71) Applicant: Martin Eugene Nix, Seattle, WA (US)

(72) Inventor: Martin Eugene Nix, Seattle, WA (US)

(21) Appl. No.: 17/803,436

(22) Filed: Jul. 7, 2022

(51) Int. Cl. B64G 1/40; B64G 1/28

(52) U.S. Cl. CPC B64G 1/407; B64G 1/288; B64G 1/409

(57) ABSTRACT

A solar space ship yacht is described, with six cylinders attached to a central-core. Contained within are rotating-water-tanks, thus pointing the solar space ship yacht at the sun. Dual parabolics focus the sun's rays onto rods, which eject steam at high velocity, utilizing high pressure pumps. A graviton is also integrated to provide artificial gravity. An incinerator gasifies garbage, thus also providing additional thrust from the gases. The net result is a solar space ship yacht that can travel from orbit to orbit, at high speeds between planets. Domes provide access and views.

### FIELD OF INVENTION

Invented is a solar space ship yacht with a solar propulsion system, an incinerator propulsion system, and a gyroscopic rotating water tank.

### PRIOR ART

U.S. Pat. No. 11,221,633. Gyroscopic Attitude Control Systems. Jan. 11, 2022. Ala. E. Illustrated is representative utilization of a gyroscope or flywheels for flight. The invented device uses rotating water to create a gyroscope for navigation and pointing-parabolics at the sun.

U.S. Pat. No. 11,085,669. Aug. 10, 2021, Sercel, J. Optics and Structure for Space Applications. Illustrated is use of solar optics for creating propellants, using captured asteroids. The invented device uses water and steam for propellant.

U.S. Pat. No. 10,738,739, Bahn, P. Aug. 11, 2020. Rocket Engine Systems. Illustrated is a rocket engine and pump. The invented device uses a pump for steam injection, with a rod at the focus of a parabolic.

U.S. Pat. No. 9,677,503. Jun. 13, 2017. Bahn, P. Rocket Engine Systems. Illustrated is a rocket system and a propellant pressure pump. The invented device uses a pump for steam injection, with a rod at the focus of a parabolic.

U.S. Pat. No. 7,028,478. Apr. 18, 2006. Prentice Ili, J. Method and Apparatus for Production of Energy. Illustrated is the production of gases, representative of incinerator technology. The invented device uses gases for trust for a space ship.

### BRIEF DESCRIPTION OF FIGURES

FIG. 1. Illustrated is a perspective view of the invented solar space ship yacht. Featured are the graviton, the six cylinders and the central-core.

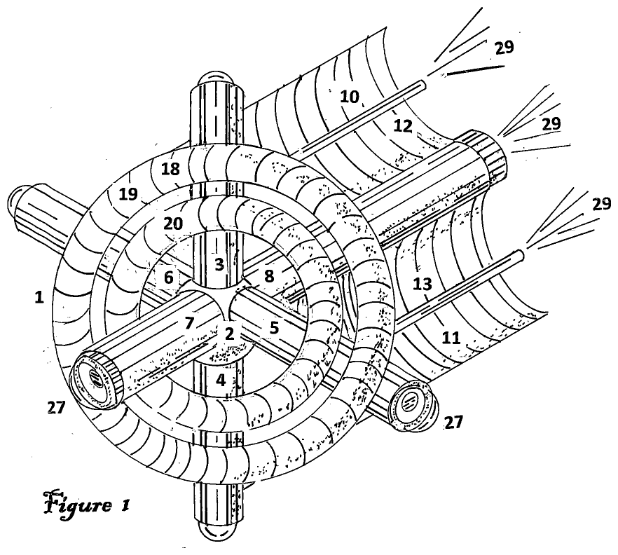

FIG. 2. Illustrated is a side view of the invented solar space ship yacht. Featured are the six cylinders and the central-core.

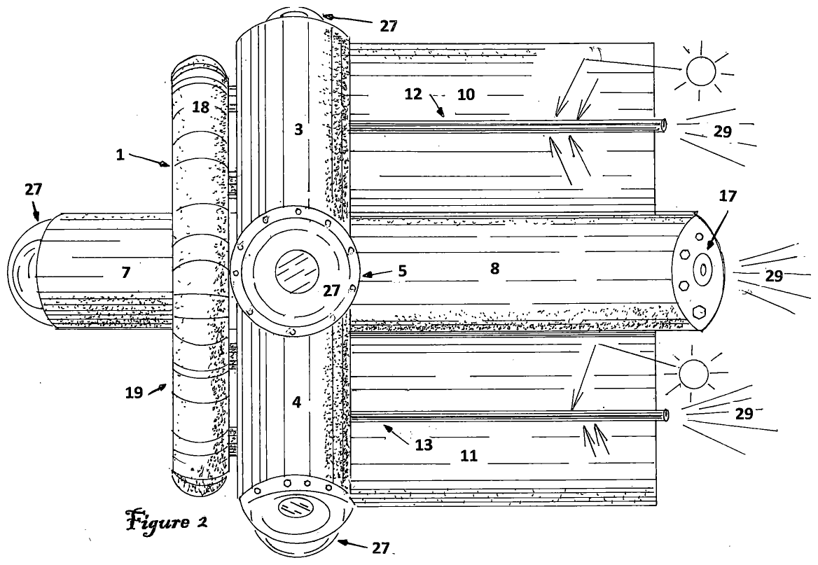

FIG. 3. Illustrated is a forward view of the invented solar space ship yacht. Featured are the six cylinders and graviton.

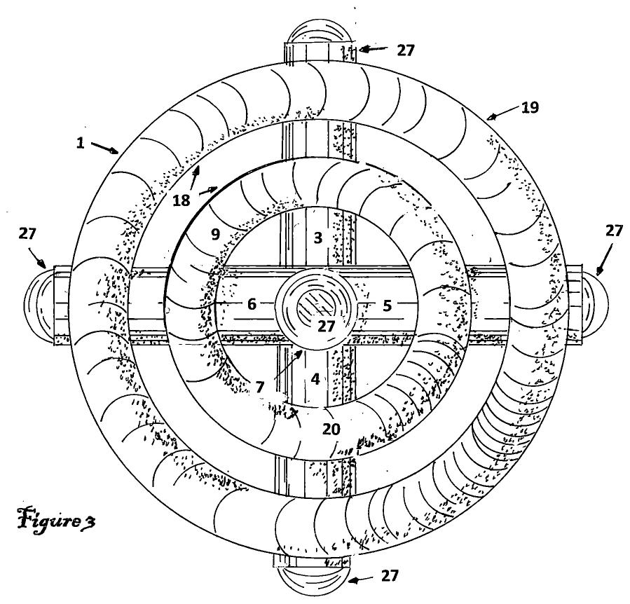

FIG. 4. Illustrated is an aft view of the invented solar space ship yacht. Featured are the six cylinders, the upper-parabolic and lower-parabolic. Shown are the central upper-focus-rod and lower-focus-rod.

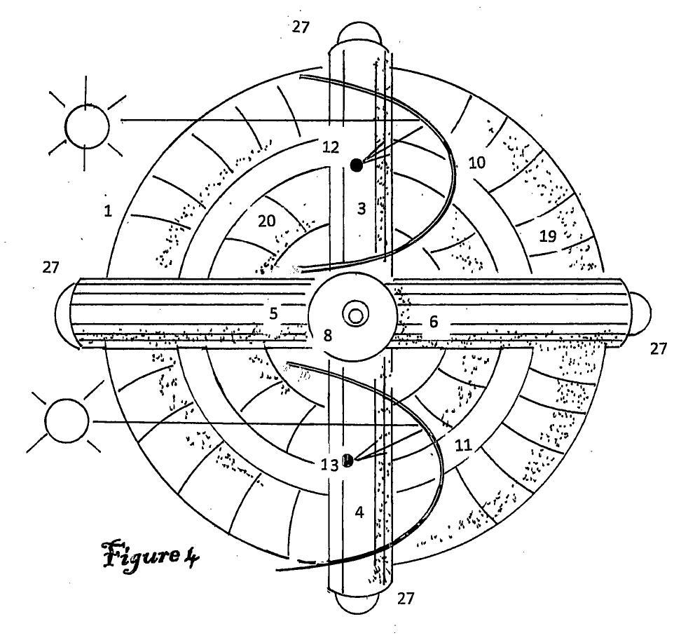

FIG. 5. Illustrated is an interior view of the invented solar space ship yacht. Featured are the various passageways and rooms.

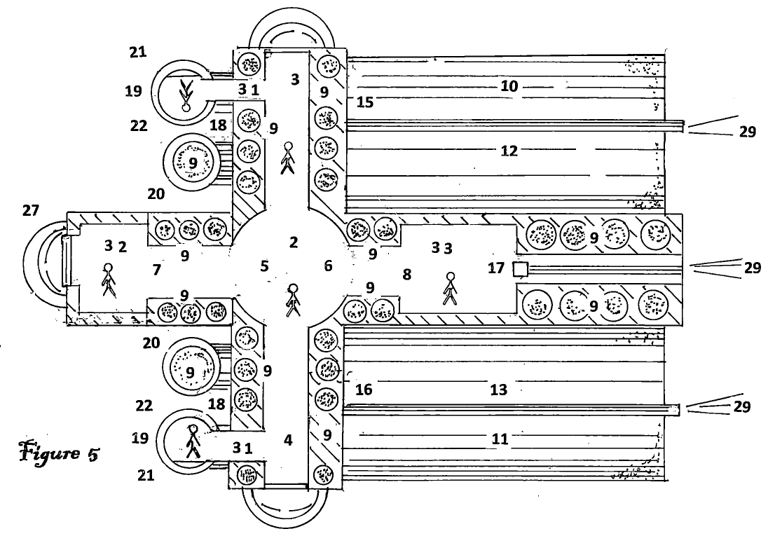

FIG. 6. Illustrated is a functional view of the rotating-race-track and graviton. Featured is a functionality of the graviton, creating artificial gravity.

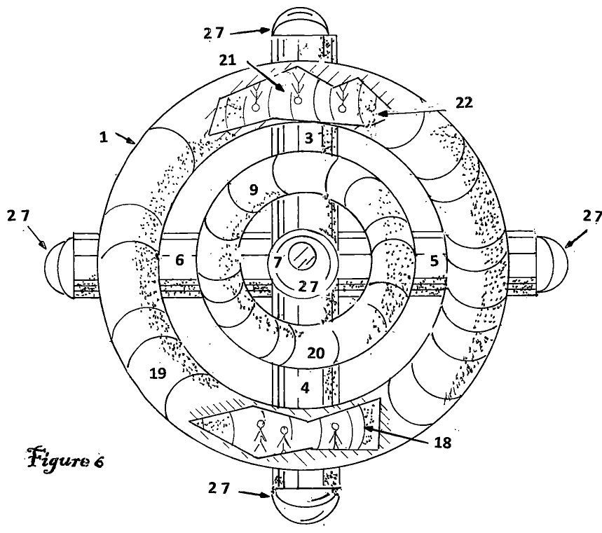

FIG. 7. Illustrated is a functional view of the parabolic solar propulsion system. Featured by the arrows, the solar energy from the sun converts the water to steam. Featured is the water to steam flow by another set of arrows. Twin parabolics feature a twin engine configuration. For communality, a lengthwise-hole is shown in both.

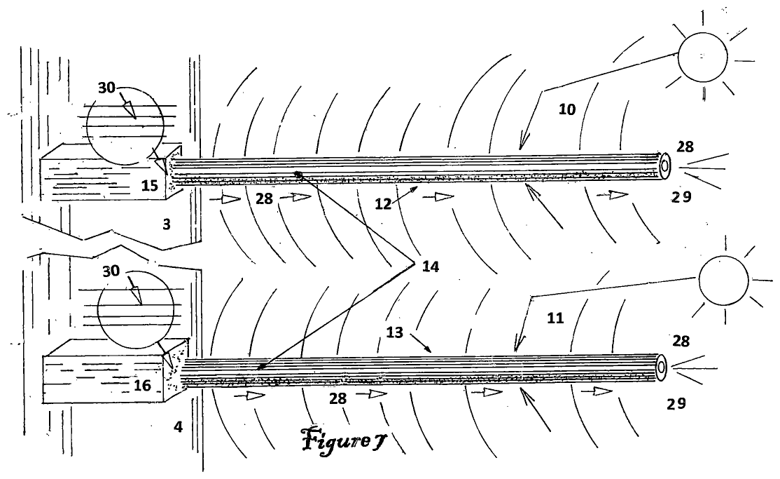

FIG. 8. Illustrated is a functional view of the incinerator propulsion system. Featured is the conversion of garbage to gasses for propulsion. For communality, a lengthwise-hole is shown in common with the upper-focus-rod and lower-focus-rod. Steam is utilized for pyrolysis.

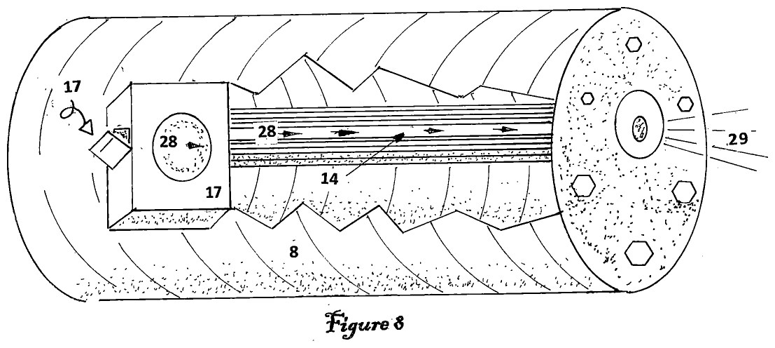

FIG. 9. Illustrated is a functional view of the rotating-water-tank gyroscopic system. Featured by the arrows is the rotation of water in tanks. The gyroscopic action of the rotating water points the entire solar-space-ship-yacht at the sun, and for navigation, thus directing the thrust.

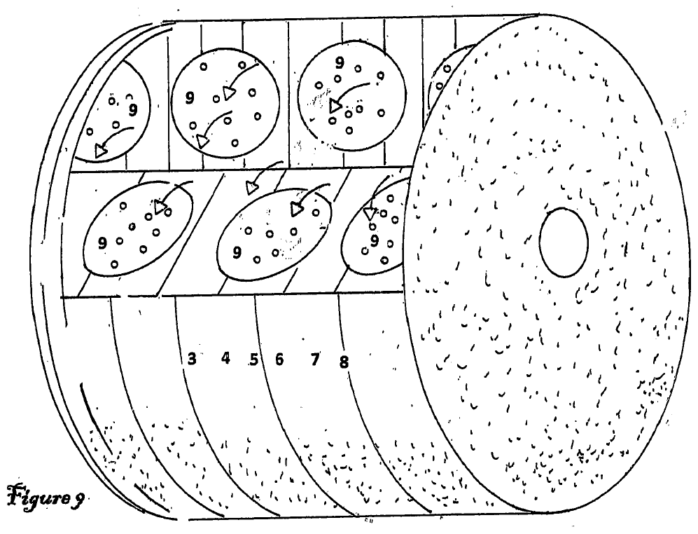

FIG. 10. Illustrated is a functional view of the transparent dome, comprised of a transparent-circular-dome, a transparent-parabolic-dome, and a transparent-linear-window. Featured is the heated gas.

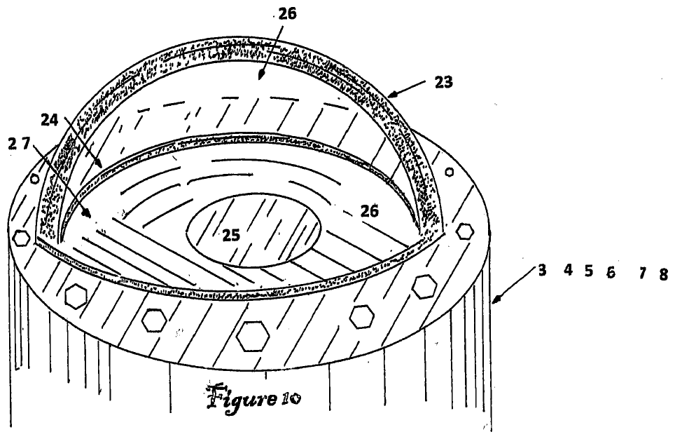

### DESCRIPTION

A solar space ship yacht is described. Central to the solar space ship yacht is the central-core. The central-core is the most protected part of the solar space ship yacht containing the engineering, navigation, and computers. Attached to the central-core are six cylinders: the upper-cylinder, the lower-cylinder, the left-cylinder, the right-cylinder, the forward-cylinder, and the aft-cylinder, all correspond to the six moments of motion. The net result is the solar space ship yacht can be pointed at the sun, and also be used to direct the thrust for navigation.

Contained within each six cylinders are rotating-water-tanks. Each rotating-water-tank forms a gyroscope, thus allowing the solar space yacht to point at the sun and, in the alternative, allows for navigation of the solar space ship yacht.

The pointing at the sun allows the sun's energy to energize the upper-parabolic and the lower-parabolic. Both are rectangular. The upper-parabolic and the lower-parabolic focus the sun's rays onto an upper-focus-rod and a lower-focus-rod. The focus of the sun's rays make the upper-focus-rod and the lower-focus-rod hot. Interior to the upper-focus-rod and lower-focus-rod is a lengthwise-hole. The lengthwise-hole is of tiny diameter. Optionally, a laser beam can be utilized to excite the steam.

An upper-pump injects water into the lengthwise-hole, and a second lower-pump injects water into another lengthwise-hole. The heat from the sun's rays thus makes the water into steam. The net result creates thrust for the solar space ship yacht. The pump is of high pressure.

The high velocity of the steam ejected from the lower-focus-rod and the upper-focus-rod thus creates thrust for the solar space ship yacht. The high speed of the steam can approach the speed of light. Thus minor amounts of propellant are used to move the large mass of the solar space ship yacht.

A secondary propulsion system is located centrally. An incinerator burns the ships garbage. The garbage is thus converted into a gas; the net result is the gas is ejected from the solar space yacht. The net result is the garbage of the ship is converted into thrust. Thus small amounts of propellant are used to move the large mass of the solar space ship yacht. Steam is utilized for pyrolysis.

In addition, there is a graviton, comprised of a forward-outer-torus and a forward-inner-torus. The forward-outer-torus contains an inner-tube. The inner-tube contains a rotating-race-track, thus creating artificial gravity. The forward-inner-torus contains rotating water, thus countering the torque created by the rotating-race-track. There are passageways to the graviton via the upper-cylinder, the lower-cylinder, the left-cylinder, and the right-cylinder. The rotating-race-track would be nice with interior lighting, and a theater, thus mimic a mountain trail or a park. There can be large rooms such as a theater or a galley.

In addition, there are domes on the ends of the forward-cylinder, the upper-cylinder, the lower-cylinder, the left-cylinder, and the right-cylinder. These domes are open able granting access for astronauts. There is an outer transparent-circular-dome, an interior transparent-parabolic-dome, and an interior transparent-linear-window. In between in the vacant space of the transparent-circular-dome and the transparent-parabolic-dome is a heated gas. In between in the vacant space of the transparent-parabolic-dome and the transparent-linear-dome is a heated gas. The heated gas helps the structural integrity of the transparent material, which can be glass, quartz or diamond. The heated gas also serves as a cushion incase a meteorite destroys the window. The heated gas repeals the meteorite and also helps protect from cosmic radiation.

Interior to the six cylinders, there is a passageway. The passageway is surrounded by the rotating-water-tanks, thus providing protection from cosmic rays. The rotating-water-tanks also distribute heat from the sun. The interior passageways all lead to the central-core. There can be large rooms, such as a space-theater, or galley.

Windows and telescopes can be also added to the passageways.

The aft-cylinder contains an incinerator. The solar space ship yacht's garbage is gasified, thus ejects from the solar space ship yacht, adding to the thrust. This provides a secondary propulsion system for the solar space ship yacht.

The water can be used to create oxygen for the solar space ship yacht, via electrolysis. Thus, the water provides a 24 hour atmosphere. Photovoltaic cells can generate electricity, and power for the upper-pump and the lower-pump. The injection of water into the upper-focus-rod and lower-focus-rod creates high velocity steam, thus creates thrust. The solar space ship yacht should approach high speeds, thus reducing travel time between planets.

The overall design of the solar space ship yacht would provide a nice home, not unlike a sail boat in the ocean. It is designed to go from orbit to orbit, utilizing water as fuel, and the sun's energy.

### DETAILED DESCRIPTION

A solar space ship yacht (1) is described. Central to the solar space ship yacht (1) is the central-core (2). The central-core (2) is the most protected part of the solar space ship yacht (1) containing the engineering, navigation, and computers. Attached to the central-core are six cylinders (3, 4, 5, 6, 7, 8): the upper-cylinder (3), the lower-cylinder (4), the left-cylinder (5), the right-cylinder (6), the forward-cylinder (7) and the aft-cylinder (8), all correspond to the six moments of motion. The net result is the solar space ship yacht (1) can be pointed at the sun and also be used to direct the thrust (29) for navigation.

Contained within each six cylinders are rotating-water-tanks (9). Each rotating-water-tank (9) forms a gyroscope, thus allowing the solar space yacht (1) to point at the sun, and in the alternative allows for navigation of the solar space ship yacht (1).

The pointing at the sun allows the sun's energy to energize the upper-parabolic (10) and the lower-parabolic (11). Both are rectangular. The upper-parabolic (10) and lower-parabolic (11) focus the sun's rays onto an upper-focus-rod (12) and a lower-focus-rod (13). The focus of the sun's rays makes the upper-focus-rod (12) and the lower-focus-rod (13) hot. Interior to the upper-focus-rod (12) and lower-focus-rod (13) is a lengthwise-hole (14). The lengthwise-hole (14) is of tiny diameter. Optionally, a laser beam may be used to excite the steam (28).

An upper-pump (15) injects water into the lengthwise-hole (14), and a second lower-pump (16) injects water into another lengthwise-hole (14). The upper-pump (15) and lower-pump (16) are of high pressure. The heat from the sun's rays thus makes the water (30) into steam (28). The net result creates thrust for the solar space ship yacht (1).

The high velocity of the steam (28) ejected from the upper-focus-rod (12) and the lower-focus-rod (13) thus creates thrust for the solar space ship yacht (1). The high speed of the steam (28) can approach the speed of light. Thus minor amounts of propellant are used to move the large mass of the solar space ship yacht (1).

A secondary propulsion system is located centrally. An incinerator (17) burns the ships garbage. The garbage is thus converted into a gas; the net result is the gas is ejected from the solar space yacht (1). The net result is the garbage of the solar space ship yacht (1) is converted into thrust. Thus small amounts of propellant are used to move the large mass of the solar space ship yacht (1).

In addition, there is a graviton (18), comprised of a forward-outer-torus (19) and a forward-inner-torus (20). The forward-outer-torus (19) contains an inner-tube (22). The inner-tube (22) contains a rotating-race-track (21), thus creating artificial gravity. The forward-inner-torus (20) contains a rotating-water-tank (9), thus countering the torque created by the rotating-race-track (21). There are passageways (31) to the graviton (18) via the interior of the upper-cylinder (3), the lower-cylinder (4), left-cylinder (5) and right-cylinder (6). The rotating-race-track (21) would be nice with interior lighting, and theater, thus mimic a mountain trail or a park.

In addition, there are domes (27) on the ends of the forward-cylinder (7), the upper-cylinder (3), the lower-cylinder (4), the left-cylinder (5), and the right-cylinder (6). These domes (27) are open able granting access for astronauts. There is an outer transparent-circular-dome (23), an interior transparent-parabolic-dome (24), and an interior transparent-linear-window (25) In between in the vacant space of the transparent-circular-dome (23) and the transparent-parabolic-dome (24) is a heated gas (26). In between in the vacant space of the transparent-parabolic-dome (24) and the transparent-linear-window (25) is a heated gas (26). The heated gas (26) helps the structural integrity of the transparent material, which can be glass, quartz or diamond. The heated gas (26) also serves as a cushion incase a meteorite destroys the window. The heated gas (26) repeals the meteorite and also helps protect from cosmic radiation.

Interior to the six cylinders (3, 4, 5, 6, 7, 8) there is a passageway (31). The passageway (31) is surrounded by the rotating-water-tanks (9), thus providing protection from cosmic rays. The rotating-water-tanks (9) also distribute heat from the sun. The interior passageways (31) all lead to the central-core (2). The passageways (31) also serve as space locks. There can be large rooms, such as a space theater (32), or galley (33).

Windows and telescopes can be also added to the passageways (31) for visual effect.

The aft-cylinder (8) contains an incinerator (17). The solar space ship's garbage (17) is gasified (28), thus ejects from the solar space ship yacht (1) adding to the thrust (29). This provides a secondary propulsion system (17) for the solar space ship yacht (1). Steam (28) is utilized for pyrolysis.

The water (30) can be used to create oxygen for the solar space ship yacht (1) via electrolysis. Thus, the water provides a 24 hour atmosphere. Photovoltaic cells can generate electricity and power for the upper-pump (15) and the lower-pump (16). The injection of water (30) into the upper-focus-rod (12) and the lower-focus-rod (13) creates high velocity steam (28), thus creates thrust (29). The solar space ship yacht (1) should approach high speeds, thus reducing travel time between planets.

The over design of the solar space ship yacht (1) would provide a nice home, not unlike a sail boat in the ocean. It is designed to go from orbit to orbit, utilizing water (30) as fuel, and the sun's energy.

1. A design of a solar-space-ship-yacht,
said solar-spaceship-yacht comprised of a central-core, a forward-cylinder, a aft-cylinder, a upper-cylinder, a lower cylinder, a left-cylinder, a right-cylinder, a upper-parabolic, a upper-focus-rod, a lower-parabolic, a lower-focus-rod, a forward-inner-torus, and a forward-outer-torus;
said central-core, attached centrally to said forward-cylinder, said aft-cylinder, said left-cylinder, said right-cylinder, said upper-cylinder, and said lower-cylinder;
the upper-cylinder attached centrally to the central-core, and attached aft to said forward-inner-torus, and attached aft to said forward-outer-torus, and forward to said upper parabolic, and to said upper-focus-rod;
the lower-cylinder attached centrally to the central-core, and attached aft to said forward-inner-torus, and attached aft to the forward-outer-torus, and forward to the lower parabolic, and to said lower-focus-rod;
the left-cylinder attached centrally to the central-core, and attached aft to the forward-inner-torus, and attached aft to the forward-outer-torus;
the right-cylinder attached centrally to the central-core, and attached aft to the forward-inner-torus, and attached aft to the forward-outer-torus;
said upper-parabolic attached centrally, perpendicular and aft to the upper-cylinder, and located horizontal and attached to the aft-cylinder;
the lower-parabolic attached centrally, perpendicular, and aft to the lower-cylinder, and located horizontal and attached to the aft-cylinder;
the upper-focus-rod attached centrally, perpendicular, aft to the upper-cylinder, and located centrally and at the focus of the upper-parabolic;
the lower-focus-rod attached centrally, perpendicular, aft to the lower-cylinder, and located centrally and at the focus of the lower-parabolic;
the forward-inner-torus located centrally around the forward-cylinder, and attached perpendicular to the upper-cylinder, the left-cylinder, the lower-cylinder, and the right-cylinder, and surrounded by the forward-outer-torus;
the forward-outer-torus located centrally, unattached, around the forward-cylinder, and attached perpendicular to the upper-cylinder, the left-cylinder, the lower-cylinder, the right-cylinder, and surrounding the forward-inner-torus;
the forward-inner-torus located forward and unattached to the central-core, and aft-cylinder;
the forward-outer-torus located forward and unattached to the central-core, and aft-cylinder;
the upper-parabolic located aft, and unattached to the forward-inner-torus, the forward-outer-torus, and the forward-cylinder;
the lower-parabolic located aft, and unattached to the forward-inner-torus, the forward-outer-torus, and the forward-cylinder;
the upper-focus-rod located aft and unattached to the forward-inner-torus, the forward-outer-torus, and the forward-cylinder, and parallel to the aft-cylinder;
the lower-focus-rod located aft and unattached to the forward-inner-torus, the forward-outer-torus, the forward-cylinder, and parallel to the aft-cylinder;
the aft-cylinder located aft and unattached to the forward-cylinder, the forward-outer-torus, and the forward-inner-torus and the forward-cylinder located forward and unattached to the aft-cylinder;
the upper-parabolic located parallel and attached to the aft-cylinder;
the lower-parabolic located parallel and attached to the aft-cylinder;
the upper-parabolic shaped as a rectangle, the lower-parabolic shaped as a rectangle;
the upper-parabolic located centrally and surrounding the upper-focus-rod;
the lower-parabolic located centrally and surrounding the lower-focus-rod;
the upper-parabolic and the lower-parabolic both with open ends in the same direction;
the upper-parabolic and lower-parabolic both the same size;
the aft-cylinder, located aft of the forward-cylinder, the upper-cylinder, the lower-cylinder, the forward-inner-torus, the forward-outer-torus, and the central-core;
the left-cylinder located opposite to the right-cylinder, and the right-cylinder located opposite to the left-cylinder;
the upper-cylinder located opposite to the lower cylinder, the lower-cylinder located opposite to the upper cylinder;
the aft-cylinder longer than the forward-cylinder, the forward-cylinder shorter than the aft-cylinder;
the upper-cylinder the same length as the lower cylinder, the lower-cylinder the same length as the upper cylinder;
the left-cylinder the same length as the right-cylinder, the right-cylinder the same length as the left-cylinder;
the forward-outer-torus located forward and unattached to the central-core, the upper-parabolic, the lower-parabolic, the upper-focus-rod, the lower-focus-rod, and the central-core;
the forward-inner-torus located forward and unattached to the central-core, the upper-parabolic, the lower-parabolic, the upper-focus-rod, and the lower-focus-rod, and the central core;
the central-core located centrally, aft and unattached to both forward-outer-torus and the forward-inner-torus; the central core located unattached, forward, and central to both the upper-focus-rod, and the lower-focus-rod;
the central-core located centrally and attached to the upper-cylinder, the lower-cylinder, the forward-cylinder, the aft-cylinder, the left-cylinder, and the right-cylinder;
the upper-focus-rod located aft, perpendicular, and unattached to the forward-cylinder, and unattached to the forward-outer-torus, and the forward-inner-torus;
the lower-focus-rod located aft, perpendicular, and unattached to the forward-cylinder, and unattached to the forward-outer-torus, and the forward-inner-torus.

2. A propulsion system for a solar space ship yacht comprised of a upper-cylinder, a lower-cylinder, a aft-cylinder, a upper-parabolic, a lower-parabolic, a upper-focus-rod, a lower-focus-rod, an incinerator, a rotating-water-tank, a upper-pump, and a lower-pump;
said upper-parabolic focusing the sun's rays onto said upper-focus-rod;
said lower-parabolic focusing the sun's rays onto said lower-focus-rod;
the upper-focus-rod containing a central lengthwise-hole, the lower-focus-rod-containing another central said lengthwise-hole;
the sun's rays making the upper-focus-rod hot, the sun's rays making the lower-focus-rod hot;
the upper-focus-rod making the lengthwise-hole hot, the lower-focus-rod making another lengthwise hole hot;
said upper-pump injecting water into the upper-focus-rod's central lengthwise-hole, a lower-pump injecting water into the lower-focus-rod's central lengthwise-hole;
the central lengthwise-hole's water of the upper-focus-rod converted to high speed steam, the central lengthwise hole's water of the lower-focus-rod converted to high speed steam;
said incinerator injecting gases into another central lengthwise-hole, the incinerator's lengthwise-hole located centrally in the center of said aft-cylinder;
said rotating-water-tank contained within said upper-cylinder, another rotating-water-tank-contained within said lower-cylinder, another rotating-water-tank contained within said left-cylinder, another rotating-water-tank contained within said right-cylinder, another rotating-tank contained within said forward-cylinder, and another rotating-tank contained within the aft-cylinder;
an assembly of rotating-water-tanks contained within the lower-cylinder, the upper-cylinder, the left-cylinder, the right-cylinder, the forward-cylinder, and the aft-cylinder;
said assembly of rotating-water-tanks creating a gyroscope in all six moments, thus pointing the upper-parabolic to the sun, and the lower-parabolic to the sun, thus focusing the sun's rays onto the upper-focus-rod, and the lower-focus-rod;
the assembly of rotating-water-tanks creating navigation in all six moments;
said high speed steam of the upper-focus-rod converted into thrust;
the high speed steam of the lower-focus-rod converted into thrust;
the ejected gases of the incinerator converted into thrust.
the assembly of rotating-water-tanks, high speed steam, and ejected gases converted into a complete propulsion and navigation system for said solar-space-ship-yacht.
